(19) United States
(12) Patent Application Publication
(10) Pub. No.: US 2026/0192384 A1
(43) Pub. Date: Jul. 9, 2026

(54) OPTICAL SYSTEM FOR CONTROLLING A LIGHT BEAM

(71) Applicant: InPhocal B.V., Eindhoven (NL)

(72) Inventors: Martijn Joseph BOERKAMP, Eindhoven (NL); Floor Anna VAN DEN BOOM, The Hague (NL); Julio RODRIGUEZ GARCIA, Eindhoven (NL)

(73) Assignee: InPhocal B.V., Eindhoven (NL)

(21) Appl. No.: 19/129,780

(22) PCT Filed: Nov. 15, 2023
(86) PCT No.: PCT/NL2023/050602

§ 371 Date: May 14, 2025

(30) Foreign Application Priority Data
Nov. 15, 2022 (NL) 2033535

(51) Int. Cl. B23K 26/06; B23K 26/064; B23K 26/08; G02B 3/00; G02B 26/08

(52) U.S. Cl. CPC B23K 26/0665; B23K 26/0643; B23K 26/0648; B23K 26/0838; G02B 3/0087; G02B 26/0816

(57) ABSTRACT

An optical system (100) comprises focusing optics (10) configured to produce a focusing beam (B) at a focal region (Fr). The focusing optics (10) 5 comprise a set of spherical surfaces (11s, 12s) configured to introduce a respective spherical aberrations into the focusing beam (B). The spherical aberrations are tuned to maximize a length (Lr) of the focal region (Fr). The system comprises at least one rotatable element (22) configured to redirect the focusing beam (B) along a variable beam direction. A gradient index 10 plate (31) is configured to receive the beam from the rotatable element (22) and linearize a dependence of a radial coordinate (R) of the focused beam in a target plane (P) as function of an angle of rotation (δ) of the rotatable element (22). Advantageously, the gradient index plate is flat and so does not introduce further aberrations which may interfere with the focusing function.

### TECHNICAL FIELD AND BACKGROUND

The present disclosure relates to an optical system for controlling the position of a light beam, e.g. used as part of a laser marking system or method of marking a target surface.

As background, US 2010/0065537 A1 describes a condensing optical system that condenses a laser beam generated by a laser source at a predetermined focal length, wherein the condensing optical system produces spherical aberration to increase a focal depth while the size of a condensed light spot is held small. The condensing optical system may be, for example, a single aspherical lens or a single diffractive condensing lens. Alternatively, the condensing optical system may be a compound optical system including at least two optical components. Also, the compound optical system may include, for example, first optical means having a light condensing function and second optical means having a spherical aberration producing function. The second optical means may be, for example, an aspherical phase plate or a diffractive phase plate. Also, the condensing optical system may further include laser beam deflecting means which is a polygonal mirror or a galvanometer mirror, in which the first optical means is an f-theta lens. Accordingly, the small spot with the large focal depth can scan on a focal plane at a high speed.

There remains a need for further simplification and improved accuracy in controlling the position of a light beam for laser marking and other purposes.

### SUMMARY

Aspects of the present disclosure relate to an optical system comprising focusing optics configured to produce a focusing beam. The system comprises beam steering optics with at least one rotatable element configured to receive the focusing beam, and redirect the focusing beam in a direction which is controlled by setting an angle of rotation of the rotatable element. The system comprises a gradient index (GRIN) plate configured to receive the redirected beam from the rotatable element, and redirect the focusing towards a target plane. The focusing beam has a focal region overlapping the target plane at a radial coordinate. The GRIN plate is configured to linearize a dependence of the radial coordinate as function of the angle of rotation.

As will be appreciated, the optical system as described herein may be particularly suitable for laser marking of products. For example, the linear dependence of the (radial) position of the beam focus as function of the rotation angle of the rotatable element, e.g. mirror, can make the system easier to control and/or improve accuracy. The GRIN plate as described herein, can be easily optimized for various focusing optics. The GRIN plate may receive a focusing beam and redirect the beam towards a well-controlled position while minimally affecting the focusing characteristics. In contrast, an f-theta lens is typically designed to receive a collimated beam and cause focusing of the collimated beam. Furthermore, in contrast to an f-theta lens, the GRIN plate is flat and so does not introduce further aberrations which may interfere with the focusing function. This is of particular importance when using the preferred focusing optics described herein, which are specifically tuned to introduce spherical aberrations in a focusing beam such that a particularly long focal region can be achieved.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A-1C illustrate simulations of an optical system wherein a radial coordinate of a focal region, overlapping a target plane, linearly depends on the angle of rotation of a rotatable element;

FIG. 2A illustrates further details of the optical system;

FIG. 2B illustrates details of a gradient index plate for linearizing a beam position, and simulated light beams traversing such plate at different angles;

FIG. 3A illustrates graphs comparing the linearity of the beam position for different systems;

FIG. 3B illustrates deviations of the graphs from an ideal linear dependence;

FIG. 4 illustrates focusing optics introducing spherical aberrations for producing an extended focal region;

FIG. 5A illustrates an intensity profile along axial and transversal coordinates of a focusing beam having spherical aberrations;

FIG. 5B illustrate a percentage the beam power passing circular regions with different radii, as function of the axial coordinate;

FIG. 6 illustrates cross-section profiles of the focusing beam at different axial positions indicated in FIG. 5A;

FIGS. 7A and 7B illustrate control of an optical system for laser marking of products.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

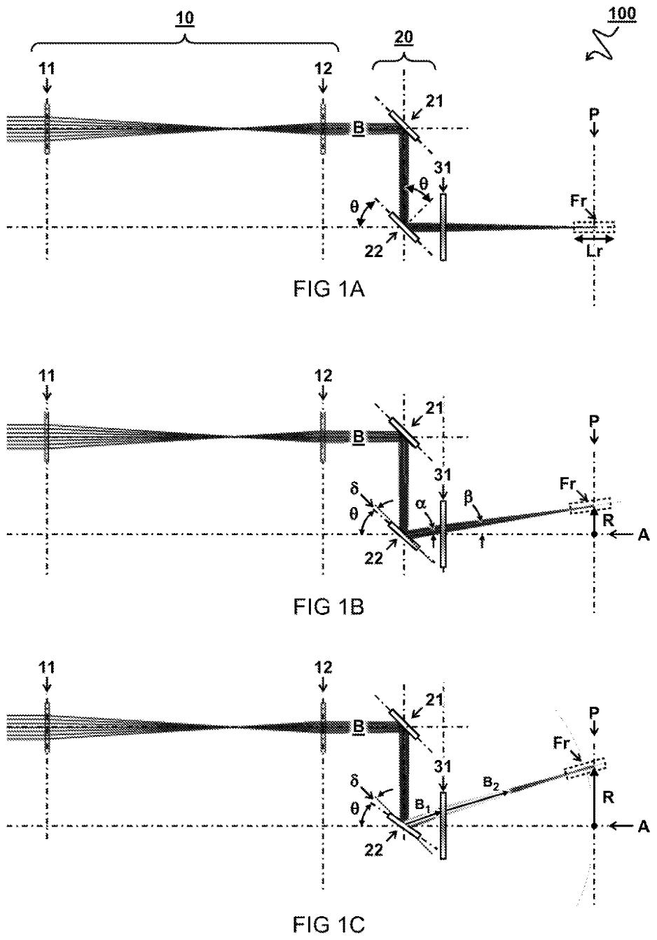

FIG. 1A-1C illustrate simulations for an embodiment of an optical system 100.

In some embodiments, the optical system 100 comprises focusing optics 10. Preferably, the focusing optics 10 comprise at least one focusing element 12 configured to produce a focusing beam B. In one embodiment, the focusing optics 10 are configured to receive a collimated light beam generated by a light source (not shown here), e.g. a laser generating a collimated (Gaussian) beam. Alternatively, the light source may also generate a divergent or convergent beam received by the focusing optics 10. Typically, the focusing optics 10 comprises at least one converging lens and/or mirror. For example, the focusing element 12 is a positive lens having a positive focal distance. Also more than one focusing element can be used, e.g. two focusing elements 11, 12. For example, the figure shows two positive lenses with a focus there between. Also other or further optical elements can be used, e.g. a combination of positive and negative lenses and/or mirrors resulting in a net convergence of a light beam received by the focusing optics 10.

In some embodiments, the optical system 100 comprises beam steering optics 20. Preferably, the beam steering optics comprise at least one rotatable element 22. In one embodiment, the rotatable element 22 is configured to receive the focusing beam B with an angle of incidence θ, and redirect the focusing beam B along a first beam direction B1. In another or further embodiment, the first beam direction B1 has a first beam angle α with respect to a central axis A. For example, the central axis A is perpendicular to a target plane P. In one embodiment, wherein the first beam angle α is controllable by setting an angle of rotation δ of the rotatable element 22. For example, the rotation may change the angle of incidence θ.

In some embodiments, a gradient index plate 31 is configured to receive the focusing beam B along the first beam direction B1, and redirect the focusing beam B along a second beam direction B2. In general, the second beam direction B2 may be different from the first beam direction B1 (except at one or more specific positions such as the central axis A and/or a ring at a specific radius around the axis where the beam direction may be unaffected). In one embodiment, the second beam direction B2 has a second beam angle β with respect to the central axis A. In another or further embodiment, the focusing beam B redirected along the second beam direction B2 has a focal region Fr overlapping the target plane P at a radial coordinate R with respect to an intersection of the central axis A with the target plane P. In preferred embodiments, as described herein, the gradient index plate 31 is configured to linearize a dependence of the radial coordinate R as function of the angle of rotation δ.

In some embodiments, the beam steering optics 20 comprise at least one rotatable mirror. In one embodiment, the beam steering optics is galvanometrically controlled, e.g. a galvanometric mirror. Also other or further types of beam steering optics can be used, e.g. a polygon mirror. For example, the FIG. 1A illustrates the rotatable element 22, formed by a rotatable mirror, is configured to reflect the focusing beam B towards the target plane P via the gradient index plate 31. Preferably, the rotatable mirror has a mirror plane coinciding with the one or more axes of rotation and/or the light beam is received coinciding the center of rotation. In this way, the origin of the reflected beam may be essentially maintained independent of the rotation angle. In a preferred embodiment, e.g. as shown, the rotatable element 22 is configured to receive the focusing beam B at a 45 degree angle of incidence θ so, the mirror can reflect the beam with a 45 degree angle of reflection along the central axis A which is directed perpendicular to the target plane P. In principle such configuration may provide an optimal range. Of course also other configurations can be envisaged, e.g. with different angles of incidence.

Alternative or in addition to reflecting optics, also or further rotatable elements can be envisaged for redirecting the beam, e.g. comprising a rotatable transmissive element affecting a direction of a transmitted beam. Also more than one rotatable element can be used, e.g. at least two rotatable elements configured to rotate around different axes. For example, the mirror 21, illustrated in FIGS. 1A-1C may be configured as a further rotatable element to rotate a direction of the beam in a direction transverse to that of the rotatable element 22. It may be noted that the use of the first rotatable element may significantly affect the position where the beam is received on the second rotatable element; and also the position where the beam will traverse gradient index plate 31. In principle, this may be taken into account when designing the gradient index plate 31, e.g. with different gradients in different directions. However, the design of the gradient index plate may be significantly simplified (e.g. radially symmetric) when using a single rotatable element capable of rotating in different directions, preferably placed in the beam path directly in front of the gradient index plate 31.

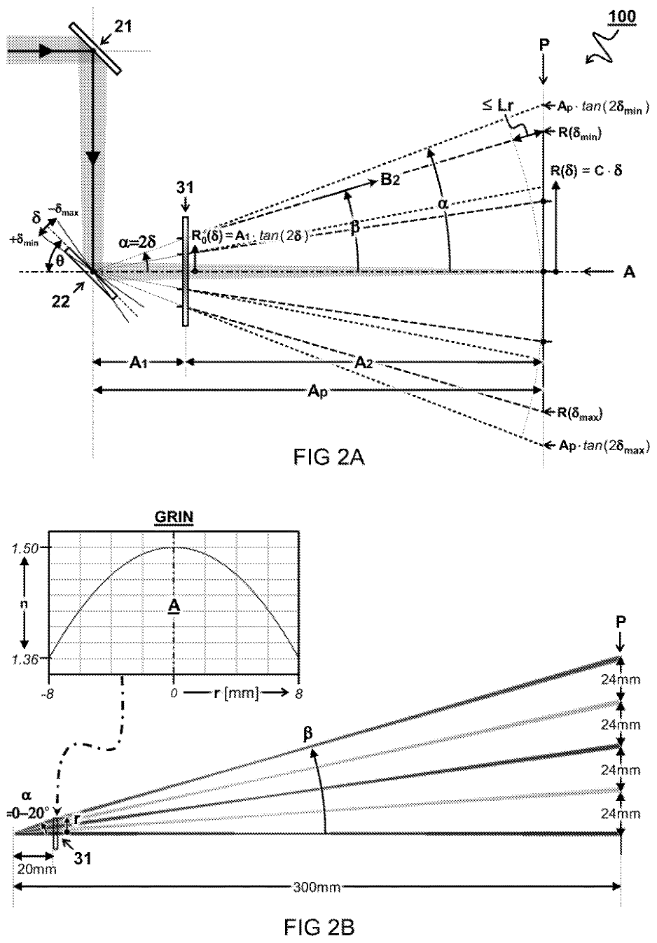

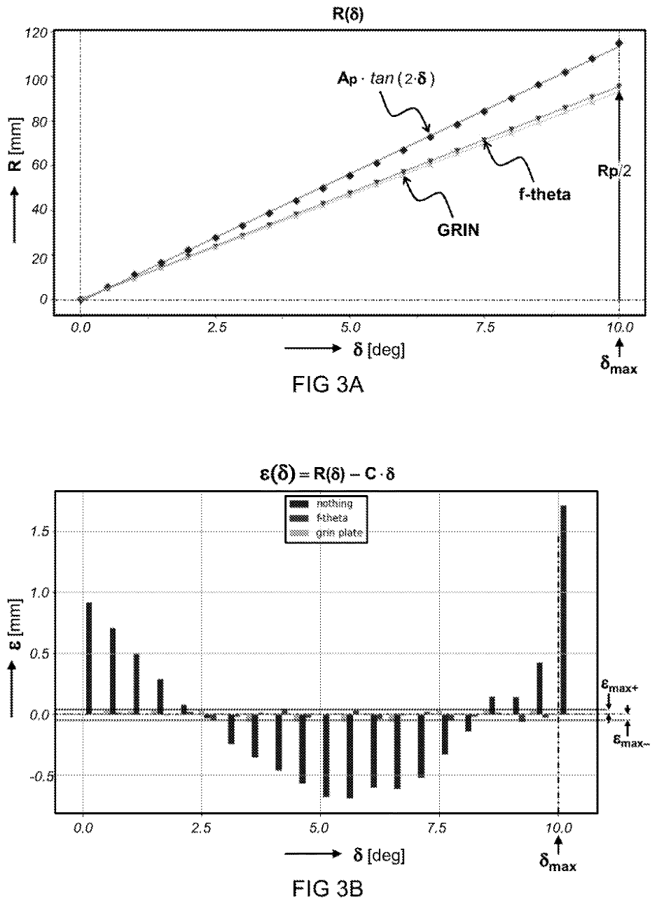

FIG. 2A illustrates further details of the optical system 100. In some embodiments, e.g. as shown, rotation of the rotatable element 22 over an angle δ causes a change in the beam direction of the reflected beam by an angle α=2δ. In other or further embodiments, e.g. as shown, the reflected beam along the first direction with first beam angle α is received by the gradient index plate 31 which may cause a slight redirection of the transmitted beam along the second beam direction B2 with a second beam angle β. As illustrated, the gradient index plate 31 receives the beam from the rotatable element 22 at a position R0 which is dependent on the first beam angle α. For example, the position can be expressed as R0=A1·tan(α)=A1·tan(2·δ). In some embodiment, the distance A1 between a center of the rotatable element 22 and the gradient index plate 31 is relatively low (short), e.g. less than ten centimeters, preferably less than five centimeter, less than three centimeter, or even less than two centimeter. This may provide a relatively compact arrangement and/or allows a relatively small plate to receive beams at various angles. In other or further embodiments, the distance A1, may be larger than five centimeter, or even larger than ten centimeter. Using larger distances may facilitate manufacturability, e.g. requiring less steep gradient. At each position R0 the gradient index plate 31 is configured to redirect the beam, received from the first beam direction B1, along a respective second beam direction B2 intersecting the target plane P (preferably directly; alternatively via further intermediate optics). More particularly, the gradient index plate 31 has a gradient index along the surface of the plate such that the position, e.g. radial coordinate R, where the beam intersects the target plane P, depends linearly on the angle of rotation δ. For example, an ideal linear dependence can be expressed as R(δ)=C·δ, where “C” is a constant. For example, in FIG. 3A C≈97 mm/10°, i.e. 9.7 millimeter per degree of rotation of the rotatable element 22.

FIG. 2B illustrates details of a gradient index plate for linearizing a beam position R, and simulated light beams traversing such plate at different angles. In some embodiments, the gradient index plate 31 comprises a gradient refractive index n along a surface of the plate, which is arranged perpendicular to the central axis A. In one embodiment, the gradient refractive index n is radially symmetric around the central axis A. Typically, the refractive index at the center of the plate differs from the refractive index at the edge of the plate, e.g. by at least 1% (factor 1.01), at least 5% (factor 1.05), up to 10% (factor 1.1), or more. For example, the refractive index has a peak at the central axis A which monotonically decreases at radial distances “r” away from the center. In the simulation shown, the refractive index of the plate as a function of the radial distance from the center of the plate (central axis A) was expressed as a quadratic equation n(r)=n₀+n₁·r+n₂·r². The constant n₀ was set at 1.5, and the constants n₁, n₂ were fitted to linearize the positional dependence of the beam at a distance of 300 mm traversing the plate at a distance of 20 mm. This yielded the constants n₁=8.6476×10⁻⁵ and n₂=−2.1919×10⁻³. So, the resulting plate with a diameter of 16 mm (radius 8 mm) has a refractive index “n” varying between 1.5 at the center and 1.36 at the edge. Of course also other gradients could be used, e.g. resulting in a smaller or larger proportionality constant “C” and/or adapted to any other optical setup.

FIG. 3A illustrates graphs comparing the linearity of the beam position R for different simulated systems. The line indicated by “GRIN” corresponds to the positions R of the beam according to the system having the gradient index (GRIN) plate as shown in FIG. 2B. The line indicated by “f-theta” corresponds to a simulation of an f-theta lens. Similar to the GRIN plate as described herein, an f-theta lens can, in principle, be used to linearize a dependence of a beam focus as function of the angle of incidence on the lens. Different from the GRIN plate as described herein, an f-theta lens is typically designed to receive a collimated beam and focus said beam, which is not desired here. Also different is that an f-theta lens is typically designed to maintain said focus at the target plane, whereas this is not necessary with the focusing optics as described herein having a relatively large depth of focus, which is generated before the GRIN plate. A yet further difference is that, compared to an f-theta lens, the GRIN plate as described herein may alleviate or completely avoid introduction of unwanted further aberrations into the beam, which could otherwise negatively affect the focal depth produced by the focusing optics described herein. The GRIN plate may also be relatively light and/or compact, e.g. can be placed close to the rotating element. Finally, the GRIN plate may be relatively inexpensive and/or save material.

For comparison, the figure also illustrates what happens if there is no further optical element placed between the rotatable element 22 and target plane P. In this case the position R can be expressed as Ap·tan(2δ), where Ap is the distance the beam traverses between the rotatable element 22 and target plane P along the central axis A. While it appears that the tangent function resembles a linear dependence for the small range of angles up to α=2δ=20°, there is in fact a significant deviation as illustrated in the following graph.

FIG. 3B illustrates deviations of the graphs from an ideal linear dependence. As illustrated, the deviation from a linear fit is relatively small for the GRIN plate and f-theta lens, while the deviation is quite significant if no linearizing element is used (indicated by “nothing”). The deviation or error ε is defined here as the difference between the respective dependence R(δ) and a linear fit C·δ, i.e. straight line through the origin having direction coefficient C minimizing the least squares difference with the function R(δ) over a working range δ=[δmin, δmax], e.g. ±10 degrees. The overall deviation can be quantified by the standard deviation of the values ε(δ)=|R(δ)−C·δ|. In the present example the standard deviation from the linear fit is 1 mm if n₀ linearizing element is used (“nothing”); 0.02 mm for the f-theta lens; and 0.03 mm for the GRIN plate, so a significant improvement.

In general, the GRIN plate may be considered to linearize the dependence R(δ) of the radial coordinate R as function of the angle of rotation δ, when the standard deviation of the difference ε(δ) between this dependence relation R(δ), and a linear fit C·δ to this dependence, is lowered by the GRIN plate, compared to a situation where no linearizing element is used. For example, the linearization should be effective over the working range (8 min, Smax) of the rotatable element, e.g. the maximum angles for which the beam still passes the GRIN plate. Preferably, the linearization results in a standard deviation less than 1% of the working range Rp=(Rδₘᵢₙ, Rδₘₐₓ), more preferably less than 0.5%, less than 0.1%, less than 0.05%, or even less than 0.02%. For example, for the present GRIN plate, the standard deviation is 0.03 mm which is only about 0.015% of the working range Rp (≈2×94 mm)

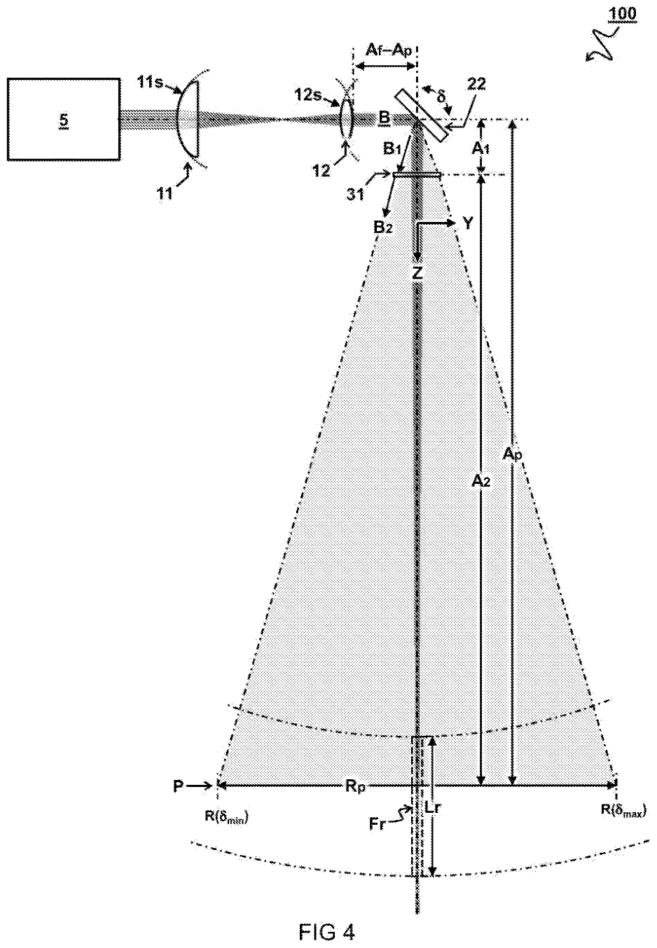

FIG. 4 illustrates focusing optics 10 introducing spherical aberrations for producing a focusing beam having an extended focal region Fr.

In some embodiments, the focusing optics 10 are configured to produce a focusing beam B with a focus at relatively long focal length Af (path length distance between the last focusing element and the target plane P), e.g. more than the working range Rp=|R(δmin)−R(δmax)| by at least a factor two. The relatively long focal length Af may correspond to a relatively long focal region and/or depth of focus. In other or further embodiments, the focusing optics 10 comprise one or more optical elements configured to introduce aberrations, e.g. spherical aberrations into the beam. The inventors find that by tuning these aberrations, it is possible to considerably extend the depth of focus, e.g. length Lr of the focal region Fr.

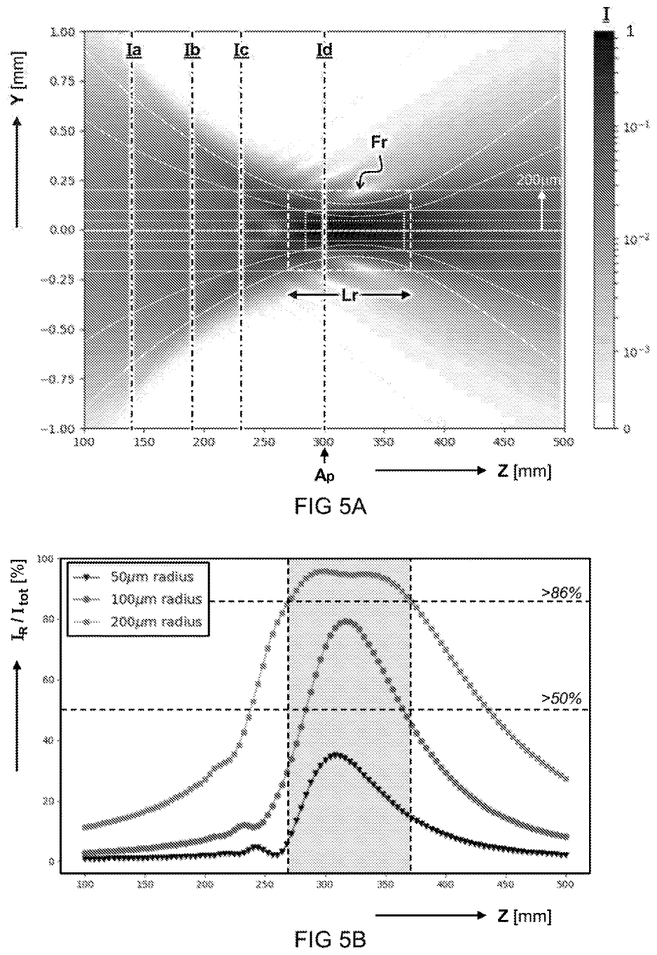

Preferably, the focusing optics 10 comprise at least one spherical element. For example, the focusing optics 10 comprise at least one spherical optical surface configured to introduce spherical aberrations into the produced focusing beam B, wherein the spherical aberrations are configured to maximize a length Lr of the focal region Fr, e.g. as defined with reference to FIGS. 5A and 5B below. More preferably, the focusing optics 10 comprise at least two spherical optical surfaces on one or more optical elements. Most preferably the focusing optics 10 comprise at least a first optical element 11 having at least one spherical surface 11s introducing a first set of spherical aberrations into the beam, and a second optical element 12 having at least one spherical surface 12s introducing second set of spherical aberrations into the beam, wherein the second optical element 12 is arranged at a distance from the first optical element 11, wherein the different sets of spherical aberrations are tuned to mutually interfere for maximizing the length Lr of the focal region Fr, e.g. as defined with reference to FIGS. 5A and 5B below. Alternatively, or in addition to lenses and/or mirrors having one or more spherical optical surfaces, also other optical elements can be envisaged such as a metalens that can introduce spherical aberrations. Preferably, though not necessarily there is a focus between the first optical element 11 and the second optical element 12. For example, the first optical element 11 is configured to focus the beam at a position before the second optical element 12. This may result in a diverging beam impinging a spherical surface of the second optical element 12 with a relatively large spread in angles, e.g. enhancing spherical aberrations. A desired spread in angles can also be provided in other or further setups, e.g. comprising a combination of negative and positive lens. This may depend on the entrance beam and lens strength. Alternatively, or additionally, the spread of angles can be variable, e.g. set by a controller for determining the spherical aberrations, focal characteristics, and/or other applications.

In one embodiment, e.g. as shown, the focusing optics 10 comprise a first optical element 11 with one spherical surface 11s facing a collimated beam received from a light source 5, e.g. laser. This spherical surface may introduce a first set of spherical aberrations in the beam. In another or further embodiment, e.g. as shown, the first optical element 11 has a flat optical surface opposite the spherical surface. Alternatively, this could also be a second spherical surface. In another or further embodiment, e.g. as shown, the focusing optics 10 comprise a second optical element 12 with a spherical surface 11s facing a beam received from the first optical element 11. Preferably, the first optical element 11 is a focusing element and the second optical element 12 is positioned beyond the focus of the first optical element 11. Accordingly, the second optical element 12 may receive a diverging beam from the first optical element 11. Alternatively, the first optical element 11 could also be a defocusing element, e.g. negative lens or mirror. Preferably, at least the second optical element 12 is a focusing element, which together with the first optical element 11 results in a convergent, non-diffractive beam. Alternatively, or in addition to light beams having a relatively large focal region based on spherical aberrations, also other non-diffractive beams can be used such as a Bessel beam. For example, a Bessel beam can be generated using an axicon and/or other optics.

As mentioned above, and shown in the figures, the GRIN plate 31 is flat. Due to its flatness, i.e. lack of any curved optical surfaces, the GRIN plate does not introduce further aberrations which may otherwise interfere with the focusing function. In particular, the flat GRIN plate does not interfere with the spherical aberrations introduced into the beam by the at least one spherical optical surface of the focusing optics 10, e.g. the spherical surfaces of the optical elements 11 and/or 12. In this way, the length Lr of the focal region Fr can be relatively unaffected, especially when the angle of the beam impacting the surface of the plate is varied by the rotatable element 22. For example, if the GRIN plate would be replaced by an f-theta lens having a curved surface, the curvature of the f-theta lens would interfere with the spherical aberrations, introduced by the preceding focusing optics 10, which are specifically tuned to maximize the length Lr of the focal region Fr. The flatness of the GRIN plate also allows it to be placed at a relatively close distance A1 with respect to the rotatable element 22, and accept the focusing beam along the direction B1 with a relatively large angle of incidence, whereas a curved optical surface placed at this position would significantly affect the focusing characteristics of the beam.

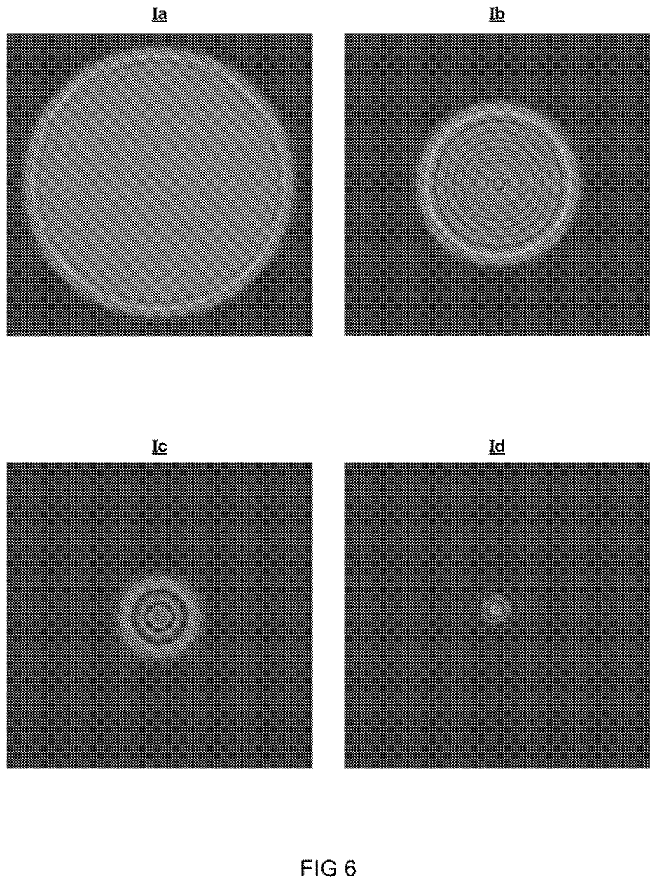

FIG. 5A illustrates an intensity profile along axial and transversal coordinates of a focusing beam having spherical aberrations; FIG. 5B illustrate a percentage the beam power Ir/Itot passing circular regions with different radii, as function of the axial coordinate Z; FIG. 6 illustrates cross-section profiles Ia, Ib, Ic of the focusing beam at different axial positions indicated in FIG. 5A.

As described herein, the focusing optics are configured to focus a light beam at a focal region Fr. The focal region Fr will be understood as a region where the beam width is relatively narrow, typically around its focus (waist) where the width of the beam is narrowest. For a Gaussian beam profile the width of the beam is typically defined as (twice) the radius of the beam where the relative intensity (irradiance) is 1/e² (13.5%) of its maximum value. More generally, the width of a beam at any axial position along the optical axis of the beam can be defined as the diameter of a (circular) region encompassing a certain percentage of the beam's power or irradiance. For example, the D86 width is defined as the diameter of the circle that is centered at the centroid of the beam profile and contains 86% of the beam power. This percentage corresponds to the relative amount of power contained in a circular Gaussian beam profile integrated down to 1/e² of its maximum value. The latter definition is more generally applicable to a beam profile with multiple peaks, in particular the beam profiles as shown, e.g. in FIG. 6, having a set of concentric rings with different intensity peaks. For example, such concentric rings may signify spherical and/or other aberrations of the focusing beam, e.g. purposely introduced by the focusing optics, as described herein.

In some embodiments, e.g. as shown in FIG. 5A, the length Lr of the focal region Fr (also referred to as depth of focus, or focal depth) is defined as the length of a section of the focusing beam, along the optical axis of the beam, where the D86 width (diameter) is less than 400 μm (i.e. radius less than 200 μm). Preferably, this length is at least one centimeter, more preferably at least five centimeter, e.g. up to ten centimeter, or more. For example, as illustrated for the present beam profile, this length Lr is about 100 mm, i.e. 10 cm. Of course also other or further definitions could be used, e.g. the length of the focal region where the D50 width is less than 200 μm (i.e. radius less than 100 μm). Preferably, this length is at least one centimeter, more preferably at least five centimeter. For example, as illustrated for the present beam profile, this length is about 8 cm. As will be appreciated, having a beam with a relatively large (long) focal depth may provide greater tolerance for overlapping the focal region Fr with a target plane P. For example, the light beam may be directed at various angles (α,β) with respect to the target plane while maintaining overlap with a relatively small beam profile and/or the position of the target plane P may be variable within the focal region Fr. For example, this may facilitate various applications such as laser marking.

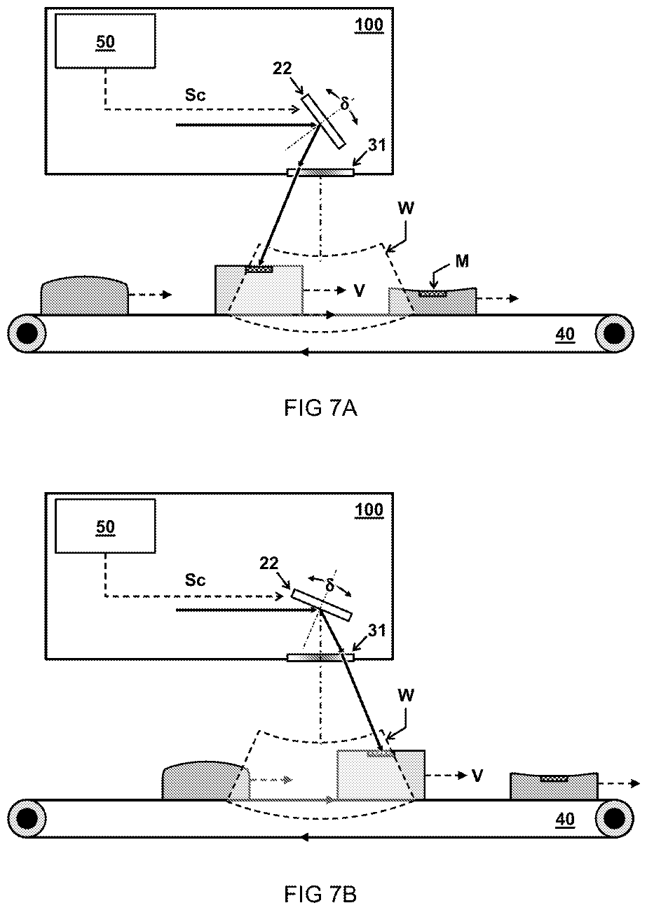

FIGS. 7A and 7B illustrate control of an optical system 100 for laser marking of products. As will be appreciated, the optical system 100 as described herein may be particularly suitable for laser marking of products. In particular, the linear dependence of the (radial) position of the beam focus on the rotation angle of the rotatable element 22, e.g. mirror, can make the system relatively easy to control and/or improve accuracy. As will also be appreciated, the relatively large focal depth can facilitate marking of various surfaces, which may vary in height and/or shape relative to a target plane.

In one embodiment, optical system 100 comprises an actuator (not shown) configured to actuate the rotatable element 22, i.e. determine the angle of rotation δ. Typically, the actuator is controllable by inputting a control signal Sc, e.g. electrical signal. For example, this can be an analogue control signal effecting a certain rotation in the actuator. Alternatively, or additionally, a digital control signal can be used. For example, a motor such as a stepper motor can be used, which is only capable of rotating in discrete steps with a fixed step size. Advantageously, by use of the linearizing GRIN plate, the fixed step size of the actuator rotation may translate into correspondingly fixed steps in the translation of the focal region along the target plane. For example, it can be prevented that the step size in the applied marker deviates at the outer edges of the range.

In one embodiment, the optical system 100 comprises a controller 50 configured to receive an image to be marked on a product. For example, the image comprises a line drawing defined by a set of X, Y coordinates. In another or further embodiment, the controller 50 is configured to control the at least one rotatable element 22, e.g. set or change the angle of rotation δ by sending a control signal Sc to an actuator of the rotatable element 22. In another or further embodiment, the controller 50 is configured to apply the marking M on the product by rotating the at least one rotatable element 22 over a respective angle of rotation δ linearly depending on coordinates of the image, e.g. the X, Y coordinates of the line drawing.

In some embodiments, e.g. as shown, the controller 50 is configured to apply the laser marking M while products move through an marking region W. For example, the marking region W is defined by a length Lr of the focal region Fr and/or a rotation range δ=[δmin, δmax] of the rotatable element 22 where the gradient index plate 31 linearizes the beam position. In one embodiment, the laser marking M is applied on a product, while the product moves through the marking region W with a constant velocity V. For example, the product is moved by a conveyor belt 40, or other transport mechanism. In another or further embodiment, the controller 50 is configured to add a constant rotation velocity (e.g. add a continuously or intermittently increasing angle with a constant rate of change) to the rotatable element 22, in addition to a variable rotation depending on the pattern to be applied, wherein the constant rotation velocity is configured to have the focusing beam B track the velocity V of the product moving through the marking region W. As will be appreciated, this allows considerably faster and/or more efficient application of markers compared to a system where the product velocity needs to be intermittently halted for applying a marking.

For the purpose of clarity and a concise description, features are described herein as part of the same or separate embodiments, however, it will be appreciated that the scope of the invention may include embodiments having combinations of all or some of the features described. For example, while embodiments were shown for a laser marking system, the optical system can also be used for other or further applications, e.g. laser writing or cutting. The various elements of the embodiments as discussed and shown offer certain advantages, such as improved control of a laser beam position. Of course, it is to be appreciated that any one of the above embodiments or processes may be combined with one or more other embodiments or processes to provide even further improvements in finding and matching designs and advantages. It is appreciated that this disclosure offers particular advantages to laser marking, and in general can be applied for any application wherein accurate control of a laser beam is important.

For the purpose of clarity and a concise description, features are described herein as part of the same or separate embodiments, however, it will be appreciated that the scope of the invention may include embodiments having combinations of all or some of the features described. For example, while the present teachings have particular advantages for optical systems generating a focusing beam and controlling a position of the focal region, also alternative systems may be envisaged by those skilled in the art having the benefit of the present disclosure for achieving a similar function and result. For example, an alternative optical system may be configured to control the position of a substantially collimated beam. For example, the alternative optical system comprises a light source and/or optical element(s) configured to generate such collimated beam. Preferably, the collimated beam has a relatively small constant beam width, e.g. having a substantially constant D86 beam width less than one millimeter, preferably less than half a millimeter, more preferably less than 250 μm. Alternatively, or in addition a non-diffractive beam can be used such as a Bessel beam. A relatively small beam but constant beam may be similarly used in various applications such as laser marking of objects. As will be appreciated, the alternative optical system may comprise the same or similar beam steering optics and gradient index plate as described herein. For example, the beam steering optics comprising at least one rotatable element configured to receive the collimated beam with an angle of incidence, and redirect the collimated beam along a first beam direction, wherein the first beam direction has a first beam angle with respect to a central axis, wherein the central axis is perpendicular to a target plane, wherein the first beam angle is controllable by setting an angle of rotation of the rotatable element to change the angle of incidence. For example, the gradient index plate is configured to receive the collimated beam along the first beam direction, and redirect the collimated beam along a second beam direction, wherein the second beam direction has a second beam angle with respect to the central axis, wherein the collimated beam redirected along the second beam direction has a substantially constant (small) beam width overlapping the target plane at a radial coordinate with respect to an intersection of the central axis with the target plane, wherein the gradient index plate is configured to linearize a dependence of the radial coordinate as function of the angle of rotation. Of course, it will be appreciated that any one of the above embodiments may be combined with one or more other embodiments (including the alternative optical system) to provide even further improvements in finding and matching designs and advantages. It is appreciated that this disclosure offers particular advantages to laser marking, and in general can be applied for any application wherein improved positional control of a beam is desired.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An optical system comprising:
focusing optics comprising a set of focusing elements configured to produce a focusing beam, wherein the set of focusing elements comprise at least one spherical surface configured to introduce a respective set of spherical aberrations into the focusing beam, wherein the spherical aberrations are tuned to maximize a length of a focal region;
beam steering optics comprising at least one rotatable element configured to receive the focusing beam with an angle of incidence, and redirect the focusing beam along a first beam direction, wherein the first beam direction has a first beam angle with respect to a central axis, wherein the central axis is perpendicular to a target plane, wherein the first beam angle is controllable by setting an angle of rotation of the rotatable element to change the angle of incidence; and
a flat gradient index plate configured to receive the focusing beam along the first beam direction, and redirect the focusing beam along a second beam direction, wherein the second beam direction has a second beam angle with respect to the central axis, wherein the focusing beam redirected along the second beam direction has a focal region overlapping the target plane at a radial coordinate with respect to an intersection of the central axis with the target plane, wherein the gradient index plate is configured to linearize a dependence of the radial coordinate as function of the angle of rotation.

2. The optical system according to claim 1, wherein the focusing beam along the first beam direction, having the spherical aberrations introduced by a preceding at least one spherical surface of the set of focusing elements, is received onto the flat gradient index plate at a variable angle of incidence in accordance with the controllable angle of rotation of the rotatable element placed directly in front of the flat gradient index plate, wherein the flatness of the gradient index plate prevents introducing further aberrations into the focusing beam received onto the gradient index plate with the variable angle of incidence, thereby maintaining the maximum length of the focal region in accordance with the tuning of the spherical aberrations.

3. The optical system according to claim 1, wherein the rotatable element is arranged in a path of the focusing beam directly in front of the gradient index plate and capable of rotating around at least two different axes of rotation.

4. The optical system according to claim 1, wherein an axial distance between a center of the rotatable element and the gradient index plate is less than five centimeters.

5. The optical system according to any of the preceding claim 1, comprising at least one actuator configured to rotate the at least one rotatable element in discrete steps having a fixed step size for the angle of rotation.

6. The optical system according to claim 1, wherein the gradient index plate comprises a gradient refractive index with a changing refractive index along a direction perpendicular to the central axis of the plate, wherein the gradient refractive index is radially symmetric around the central axis.

7. The optical system according to claim 1, wherein the focusing optics comprise at least a first optical element having at least one spherical surface introducing a first set of spherical aberrations into the beam, and a second optical element having at least one spherical surface introducing second set of spherical aberrations into the beam, wherein the second optical element is arranged at a distance from the first optical element, wherein different sets of spherical aberrations are tuned to mutually interfere for maximizing a length of the focal region.

8. The optical system according to claim 1, wherein a first length of the focal region is defined as the length of a section of the focusing beam, along an optical axis of the beam, where a D86 width is less than 400 μm, wherein a second length of the focal region is defined as the length of a section of the focusing beam where a D50 width is less than 200 μm, wherein the first length and the second length are both at least five centimeters.

9. The optical system according to claim 1, wherein the focusing optics is configured to receive a collimated light beam from a laser.

10. A laser marking system comprising:
the optical system according to claim 1; and
a controller configured to receive an image of a marking to be applied to a surface, and control a rotatable element to apply the marking.

11. The laser marking system according to claim 10,
wherein the controller is configured to apply the marking by rotating the rotatable element over a respective angle of rotation linearly depending on respective coordinates of features in the received image.

12. The laser marking system according to claim 11, wherein the controller is configured to apply the marking while products move through a marking region, wherein the marking is applied on a product while the product moves through the marking region with a constant velocity, wherein the controller is configured to add a constant rotation velocity to the rotatable element, in addition to a variable rotation depending on a pattern to be applied, wherein the constant rotation velocity is configured to have the focusing beam track the product moving through the marking region with the constant velocity.

13. The laser marking system according to claim 12 comprising a laser configured to direct a collimated laser beam into the focusing optics, wherein the controller is configured to control a light intensity of the focusing beam intersecting the target plane.
